(19) United States
(12) Patent Application Publication
(10) Pub. No.: US 2008/0123123 A1
(43) Pub. Date: May 29, 2008

(54) DOCUMENT MANAGEMENT BODY PROCESSING APPARATUS AND COMPUTER READABLE MEDIUM

(75) Inventor: Shingo KAWAHARADA, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/871,364

(22) Filed: Oct. 12, 2007

(30) Foreign Application Priority Data
Nov. 27, 2006 (JP) 2006-318950

(51) Int. Cl. G06K 1/00

(52) U.S. Cl. 358/1.12

(57) ABSTRACT

A document processing apparatus includes a display processing unit, a target area acceptance unit, an operation acceptance unit and edit unit. The display processing unit displays an image which represents a document having pieces of document information collectively ordered. The target area acceptance unit accepts specifying a target area, from a user, including first and second images which represent documents, respectively. The operation acceptance unit accepts a certain command from the user with the target area specified. The edit unit removes, in response to the accepting of the certain command, certain document information from the document represented by the first image. And the edit unit adds the removed document information to the document represented by the second image.

### CROSS-REFERENCE TO RELATED APPLICATIONS

This application is based on and claims priority under 35 USC 119 from Japanese Patent Application No. 2006-318950 filed Nov. 27, 2006.

### BACKGROUND

1. Technical Field

This invention relates to a document management body processing apparatus and a computer readable medium.

2. Related Arts

Hitherto, an electronic document has been created as a computer performs data processing; the effective use of information resources has been made and work efficiency has been improved by creating an electronic document using a part or all of another electronic document rather than creating an electronic document from scratch.

Thus, for example, a function of separating a predetermined page from an electronic document, a function of binding an electronic document to another electronic document, and the like are provided in a computer and usually the function is often executed upon reception of operation entry using an input device such as a mouse and a modifier key (for example, Alt key) may be used in combination depending on operation.

To bind electronic documents, it is a common practice to drag the icon of the electronic document displayed on a screen and drop it onto the icon of the electronic document to bind to combine the two electronic documents.

To separate a page from an electronic document, for example, a method of operating a metaphor (an image simulating a clip, etc.,) given to the icon of the electronic document with a mouse to give a page separation command or giving a page separation command according to a popup menu displayed with the click of the right mouse button is known. Specifying the page to be separated from an electronic document is implemented as a function of representing the electronic document on a screen as a thumbnail icon using a reduced image of a predetermined page of the electronic document, allowing page feed to be made on the thumbnail icon, and separating the displayed page as the thumbnail icon.

### SUMMARY

A document processing apparatus includes a display processing unit, a target area acceptance unit, an operation acceptance unit and edit unit. The display processing unit displays an image which represents a document having pieces of document information collectively ordered. The target area acceptance unit accepts specifying a target area, from a user, including first and second images which represent documents, respectively. The operation acceptance unit accepts a certain command from the user with the target area specified. The edit unit removes, in response to the accepting of the certain command, certain document information from the document represented by the first image. And the edit unit adds the removed document information to the document represented by the second image.

### BRIEF DESCRIPTION OF THE DRAWINGS

An Exemplary embodiment of the present invention will be described in detail based on the following figures, wherein:

FIG. 1 is a drawing to show the configuration of a document management body processing apparatus according to an exemplary embodiment of the invention;

FIG. 2 is a drawing to describe data of an electronic document according to the exemplary embodiment of the invention;

FIG. 3 is a drawing to describe data of a thumbnail image according to the exemplary embodiment of the invention;

FIG. 4 is a flowchart to describe separating processing of the tail page of an electronic document according to the exemplary embodiment of the invention;

FIG. 5 is a drawing to show a display example according to the exemplary embodiment of the invention;

FIG. 6 is a drawing to show a display example according to the exemplary embodiment of the invention;

FIG. 7 is a drawing to show a display example according to the exemplary embodiment of the invention;

FIG. 8 is a drawing to show a display example according to the exemplary embodiment of the invention;

FIG. 9 is a flowchart to describe separating processing of the top page of an electronic document according to the exemplary embodiment of the invention;

FIG. 10 is a drawing to show a display example according to the exemplary embodiment of the invention;

FIG. 11 is a flowchart to describe separating processing of the top page of an electronic document according to the exemplary embodiment of the invention;

FIG. 12 is a drawing to show a display example according to the exemplary embodiment of the invention; and

FIG. 13 is a flowchart to describe page exchange processing between electronic documents according to the exemplary embodiment of the invention.

### DETAILED DESCRIPTION

The invention will be discussed specifically based on an exemplary embodiment.

In the description of the exemplary embodiment, an electronic document (document management body) of collectively ordering plural pages (document information) is taken as an example. In the exemplary embodiment, a thumbnail image of a reduced image of the top page of the electronic document is used as a representation image representing the electronic document (in the description of the exemplary embodiment, an icon is taken as an example).

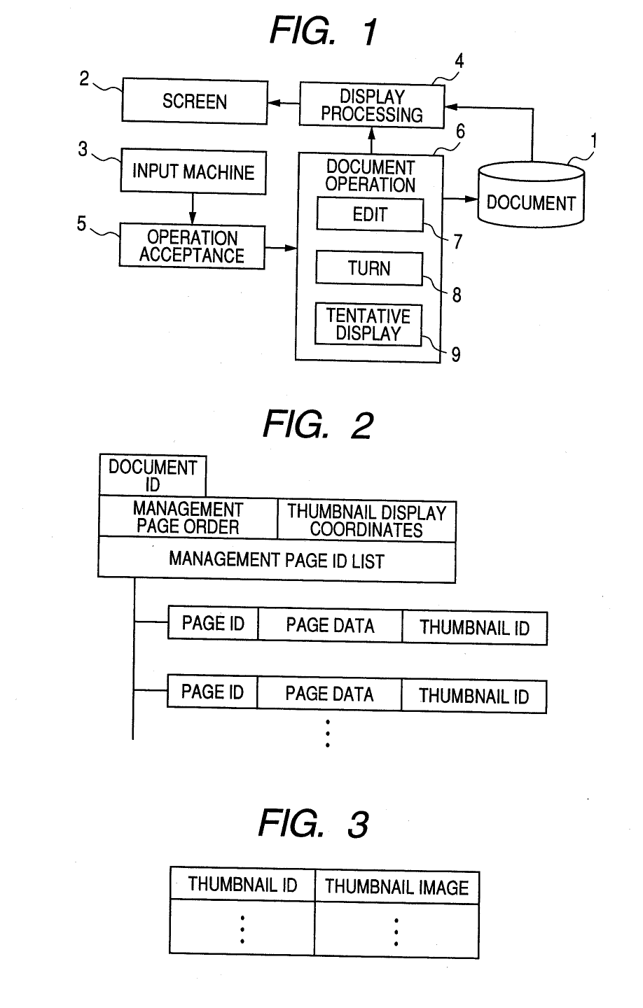

FIG. 1 shows the configuration of a document management body processing apparatus according to the exemplary embodiment.

The document management body processing apparatus of the exemplary embodiment includes document retention unit 1 for retaining information of a plurality of electronic documents, a screen 2 implemented as a liquid crystal display, etc., for displaying various pieces of information, an input machine 3 implemented as a mouse, a keyboard, etc., display processing unit 4 for performing processing of displaying the icons of electronic documents on the screen 2, operation acceptance unit 5 for accepting various operation inputs responsive to operation of the input machine 3 by the user, and document operation unit 6 for performing operation on any electronic document in response to the accepted operation input. The operation acceptance unit 5 of the exemplary embodiment is formed as target area acceptance unit and operation acceptance unit according to the invention.

The document operation unit 6 includes edit unit 7 for performing processing of separating/binding a predetermined page of an electronic document, turn unit 8 for performing processing of turning the pages of an electronic document in order, and tentative display unit 9 for performing processing of producing preview display of the thumbnail image of the page to be separated from an electronic document on the screen 2.

The above-described processing is assigned to a predetermined key of the keyboard and the processing assigned to the key is performed in response to pressing the key with the icon selected and the user can tailor the assignment to his or her liking.

The document management body processing apparatus of the exemplary embodiment has hardware resources of a medium access section for making data access to an external storage medium, an HDD (Hard Disk Drive), RAM (Random Access Memory), a CPU (Central Processing Unit), etc., reads a distribution management program from the storage medium or HDD storing the distribution management program, expands the distribution management program in the RAM, and causes the CPU to perform computation processing, whereby the display processing unit 4, the operation acceptance unit 5, and the unit 7 to 9 in the document operation unit 6 are formed, but the functional unit may be implemented as hardware.

In the exemplary embodiment, the document management body processing apparatus is formed in one computer; however, for example, another server to which the document retention unit 1 is connected via a network may be included and any configuration may be adopted if necessary information can be transferred among the functional unit.

Each electronic document stored in the document retention unit 1 is made up of document management information for managing the pages contained in the electronic document and page information retaining the real data of the pages. FIG. 2 shows the data structure of the electronic document.

The document management information has a “document ID” for identifying the electronic document, “management page order” for defining the arrangement order of the pages contained in the electronic document, “thumbnail display coordinates” indicating the position on the screen displaying the thumbnail image as an icon, and a “management page ID list” for determining the pages contained in the electronic document.

The page information has a “page ID” for identifying each page, “page data” of the real data of each page, and a “thumbnail ID” for identifying the thumbnail image of each page.

In the exemplary embodiment, the thumbnail image is previously created based on the real data of the page and is associated with the “thumbnail ID” for management as shown in FIG. 3, but a thumbnail image may be created at any time as required.

The “management page ID list” of the document management information contains the page IDs for identifying the pages contained in the electronic document, and the arrangement of the page IDs is set according to the “management page order.” Therefore, any page can be bound/separated by adding/deleting the page ID to/from the “management page ID list” and page turning can be executed by changing the “management page order.”

In the exemplary embodiment, the document management information and the page information are separated as the data structure, but the exemplary embodiment is not limited to the data structure and, for example, the real data of the pages may be contained in the “management page ID list.”

Next, processing of the document management body processing apparatus of the exemplary embodiment will be discussed specifically.

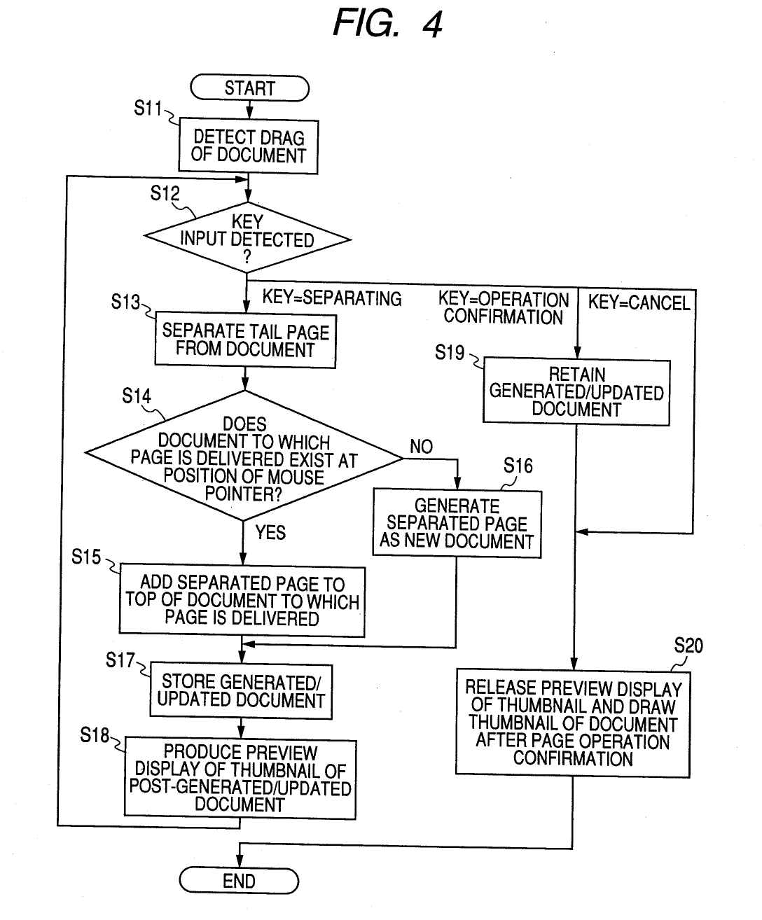

FIG. 4 shows a processing procedure of separating the tail page of an electronic document.

If the user presses a predetermined key of the keyboard in a state in which the user drags the icon of any electronic document displayed on the screen with the mouse and specifies the area to which the dragged icon is moved as the target area (the icon is contained in the target area), the operation acceptance unit 5 detects the operation and provides the information for the document operation unit 6 (steps S11 and S12).

If the user presses the key to which processing of separating the tail page of an electronic document is assigned, the document operation unit 6 first deletes the page ID of the tail page of the electronic document corresponding to the dragged icon from the “management page ID list,” thereby separating the tail page of the electronic document (step S13).

Next, the document operation unit 6 determines whether or not an electronic document to which the page is delivered exists at the position pointed to by the mouse pointer (namely, the dragged icon overlaps another icon) (step S14). If an electronic document to which the page is delivered exists, the deleted page ID is added to the top of the “management page ID list” of the electronic document, whereby the separated page is bound to the top of the electronic document to which the page is delivered (step S15) On the other hand, if an electronic document to which the page is delivered does not exist, new document management information is generated and the deleted page ID is added to the “management page ID list” of the document management information, whereby the separated page is generated as a new electronic document (step S16).

Then, the document management information generated/updated by performing the processing is stored in memory (step S17) and the display processing unit 4 produces preview display of the icon of the post-generated/updated electronic document on the screen 2 based on the document management information in the memory (step S18) and waits until the user further presses a predetermined key.

If the user again presses the key to which separating processing is assigned, steps S13 to S18 are repeated. If the user presses a key to which operation confirmation processing is assigned, the generated/updated document management information stored in the memory is stored in the document retention unit 1 (step S19) and the icon preview display is released and icon is drawn based on the document management information after page operation confirmation (step S20). If the user presses a key to which cancel processing is assigned or executes drop onto a predetermined out-of-management area, the document management information stored in the memory is discarded and drawing is again performed from the beginning in the state before operation (step S20).

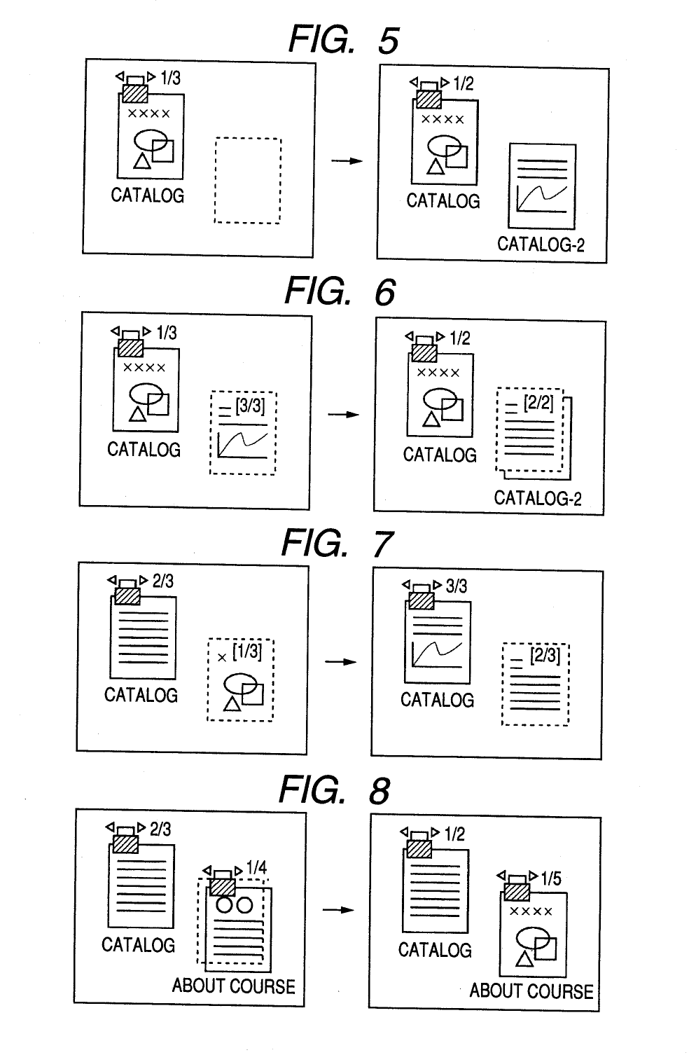

FIG. 5 shows an example of performing the processing of separating the tail page of the electronic document described above. That is, if the user drags the icon of electronic document “catalog” made up of three pages to an area where another icon does not exist (area indicated by the dashed line) and performs predetermined operation as shown at the left of the figure, the tail page (third page) of the electronic document “catalog” is removed, the electronic document “catalog” becomes a two-page electronic document, the removed page is newly generated as electronic document “catalog-2,” and an icon thereof is displayed in the area indicated by the dashed line as shown at the right of the figure.

The icons of plural electronic documents can also be collectively dragged for processing, in which case the tail page of each of the electronic documents is removed and an electronic document containing the tail page is created.

If the user presses the key to which separating processing is assigned together with a predetermined modifier key (for example, Alt key), the tail page can also be copied to create a new electronic document without removing the tail page from the original electronic document.

In the exemplary embodiment, if the user presses a key to which preview display is assigned in the drag state of the icon of an electronic document, the tentative display unit 9 produces preview display of the thumbnail image of the tail page to be separated in the area to which the icon will be dragged and previous check before the tail page is separated can be made.

That is, translucent preview display of the thumbnail image (document content representation image) of the tail page to be separated (third page) is produced in the area to which the icon is dragged (area indicated by the dashed line) as shown at the left of FIG. 6 and after the tail page is separated, the second page becomes a new tail page and preview display of the thumbnail image of the tail page is produced as shown at the right of the figure.

In the exemplary embodiment, “page number/total number of pages” is displayed in the upper right portion of the thumbnail image in the preview display for enabling the user to easily keep track of the current tail page. In fact, preview display is produced in an area slightly shifted from the area to which the icon is dragged for preventing the dragged icon from hiding the preview display.

In the exemplary embodiment, if the user presses a key to which forward turn or backward turn is assigned in the drag state of the icon of an electronic document, the turn unit 8 changes the “management page order” of the document management information. In the forward turn, the top page moves to the tail; in the backward turn, the tail page moves to the top, enabling the user to switch the tail page to be separated in order for selection.

That is, as shown at the left of FIG. 7, forward turn processing is performed, whereby the top page (first page) is moved to the tail, the thumbnail image of the second page of a new top page is displayed as a dragged icon, and translucent preview display of the thumbnail image of the first page of a new tail page is produced in the area to which the icon is dragged (area indicated by the dashed line) as the page to be separated. The forward turn processing is further performed, whereby the third page becomes the top page and the second page becomes the tail page as preview display, as shown at the right of the figure.

FIG. 8 shows an example of performing processing of separating the tail page of an electronic document and binding the page to the top of another electronic document. That is, if the user drags the icon of electronic document “catalog” made up of three pages to an area (area indicated by the dashed line) overlapping the icon of electronic document “about course” made up of four pages and performs predetermined operation as shown at the left of the figure, the tail page of the electronic document “catalog” is removed, the electronic document “catalog” becomes a two-page electronic document, and the removed page is bound to the top page of the electronic document “about course” as shown at the right of the figure.

If the user presses the key to which separating processing is assigned together with a predetermined modifier key (for example, Alt key), the tail page can also be copied and bound to the top of another electronic document.

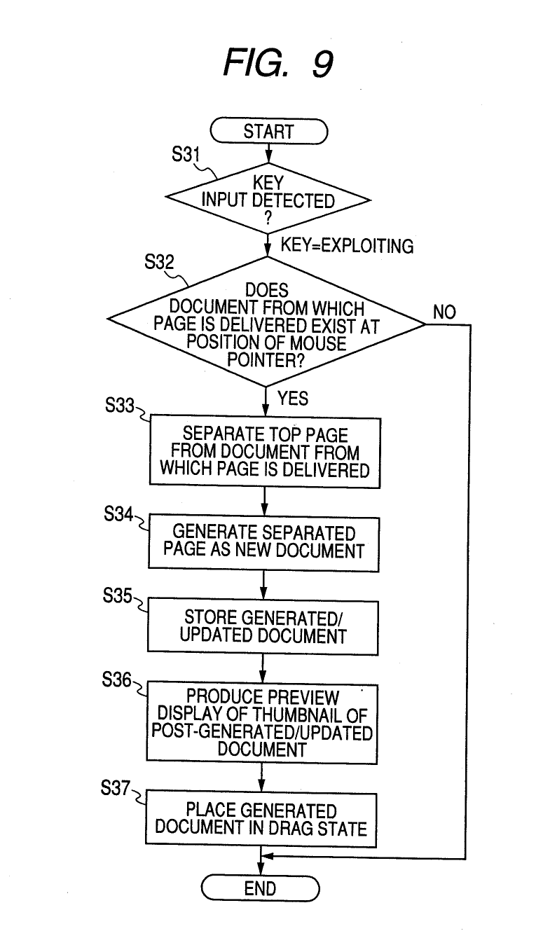

FIG. 9 shows a processing procedure of separating the top page of an electronic document to create a new electronic document.

If the user presses a predetermined key of the keyboard in a state in which the user points to the icon by the mouse pointer for specifying the display area of the icon as the target area, the operation acceptance unit 5 detects the operation and provides the information for the document operation unit 6 (step S31).

If the user presses a key to which processing of separating (exploiting) the top page of an electronic document is assigned, the document operation unit 6 determines the electronic document corresponding to the icon at the position pointed to by the mouse pointer (step S32) and deletes the page ID of the top page of the electronic document from the “management page ID list,” thereby separating the top page of the electronic document (step S33).

Next, new document management information is generated and the deleted page ID is added to the “management page ID list” of the document management information, whereby the separated page is generated as a new electronic document (step S34). Then, the generated/updated document management information is stored in the memory (step S35) and the display processing unit 4 produces preview display of the icon of the post-generated/updated electronic document on the screen 2 based on the document management information in the memory (step S36) and the icon (thumbnail image) of the generated electronic document is placed in a drag state (step S37).

Then, the user moves the icon in the drag state to a predetermined area and drops, thereby storing the document management information in the memory in the document retention unit 1 and confirming the processing. On the other hand, if the user presses the key to which cancel processing is assigned in dragging the icon or executes drop onto a predetermined out-of-management area, the document management information stored in the memory is discarded and drawing is again performed from the beginning in the state before operation.

If the user presses the key to which separating processing is assigned together with a predetermined modifier key (for example, Alt key), the top page can also be copied and created as a new electronic document.

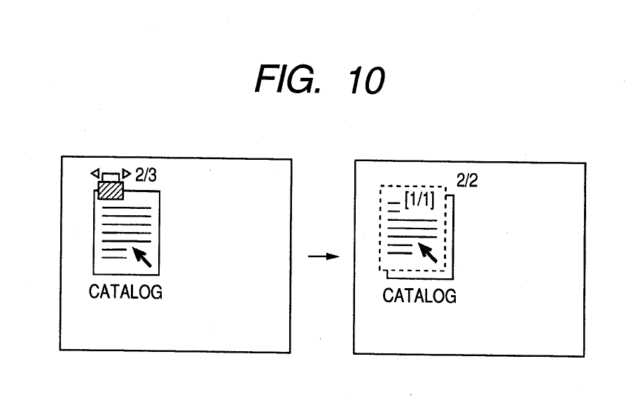

FIG. 10 shows an example of performing the above-described processing of separating the top page of an electronic document to create a new electronic document. That is, if the user selects the icon of electronic document “catalog” made up of three pages and performs predetermined operation as shown at the left of the figure, the top page of the electronic document “catalog” is removed, the electronic document “catalog” becomes a two-page electronic document, the removed page is created as a new electronic document, and the icon of the new electronic document is placed in a drag state as indicated by the dashed line, as shown at the right of the figure.

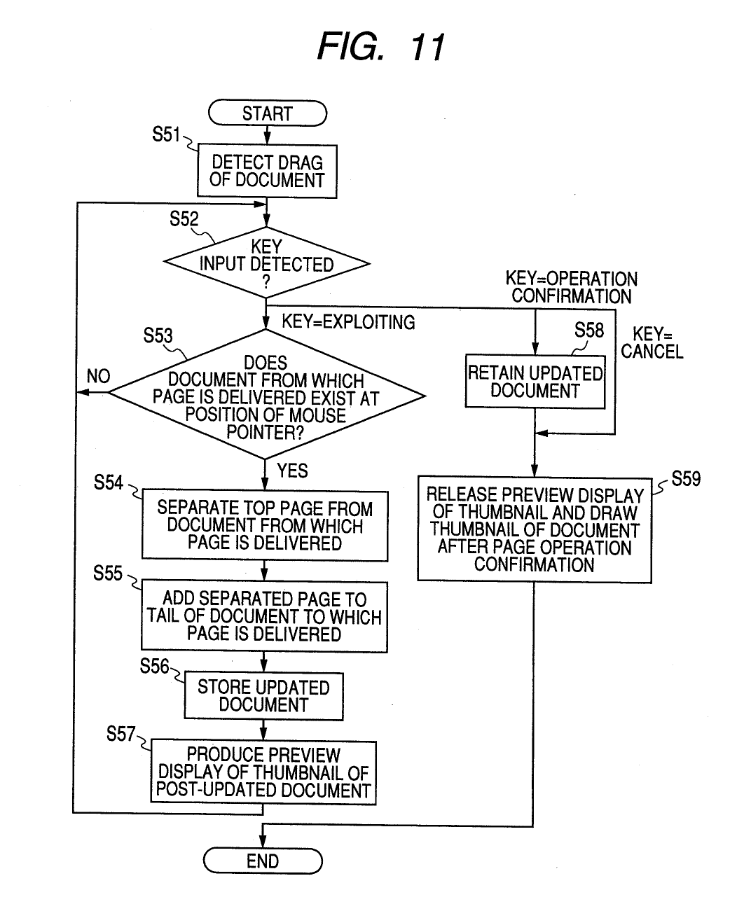

FIG. 11 shows a processing procedure of binding the page separated from the top of another electronic document to the tail of one electronic document.

If the user presses a predetermined key of the keyboard in a state in which the user drags the icon of the electronic document displayed on the screen with the mouse and specifies the area to which the dragged icon is moved as the target area (the icon is contained in the target area), the operation acceptance unit 5 detects the operation and provides the information for the document operation unit 6 (steps S51 and S52).

If the user presses the key to which processing of separating (exploiting) the top page of an electronic document is assigned, the document operation unit 6 determines whether or not the electronic document from which the page is delivered exists at the position pointed to by the mouse pointer (namely, the dragged icon overlaps another icon) (step S53). If the electronic document from which the page is delivered exists, the page ID of the top page of the “management page ID list” of the electronic document is deleted, whereby the top page of the electronic document is separated (step S54).

Next, the deleted page ID is added to the tail of the “management page ID list” of the electronic document corresponding to the dragged icon, whereby the separated page is bound to the tail of the electronic document to which the page is delivered (step S55).

Then, the document management information updated by performing the above-described processing is stored in the memory (step S56) and the display processing unit 4 produces preview display of the icon of the post-generated/updated electronic document on the screen 2 based on the document management information in the memory (step S57) and waits until the user further presses a predetermined key.

If the user again presses the key to which separating (exploiting) processing is assigned or if the user executes drop onto an area where another icon does not exist, steps S53 to S57 are repeated. If the user presses the key to which operation confirmation processing is assigned, the updated document management information stored in the memory is stored in the document retention unit 1 (step S58) and the icon preview display is released and icon is drawn based on the document management information after page operation confirmation (step S59). If the user presses the key to which cancel processing is assigned or executes drop onto a predetermined out-of-management area, the document management information stored in the memory is discarded and drawing is again performed from the beginning in the state before operation (step S59).

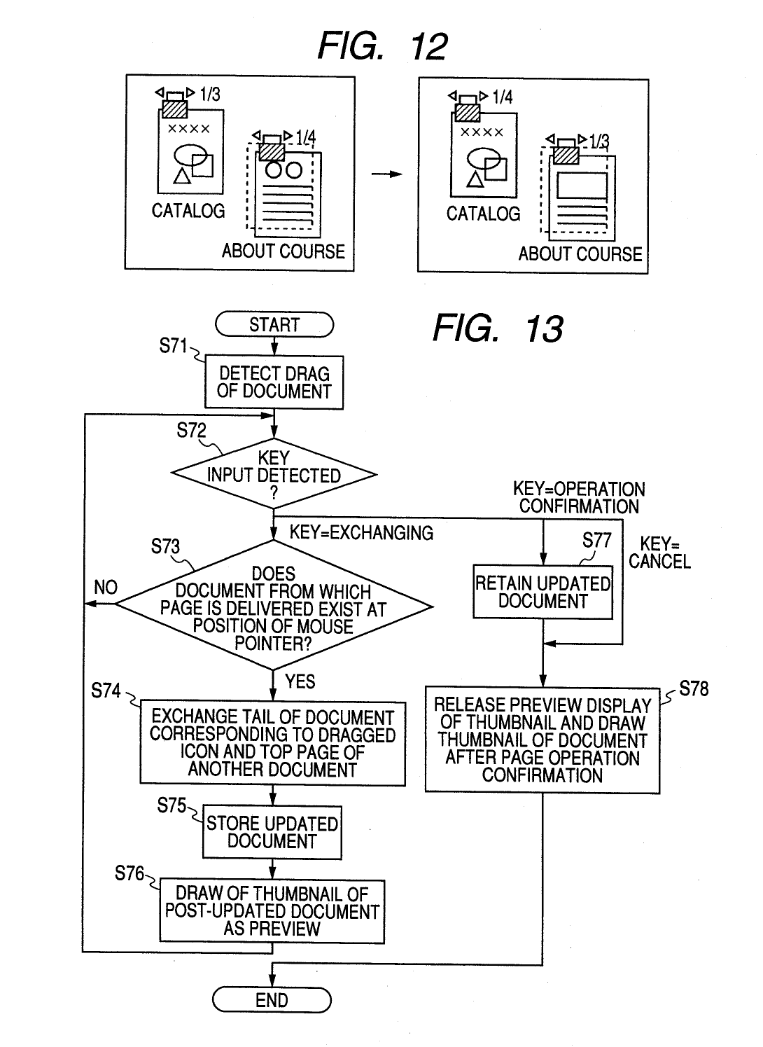

FIG. 12 shows an example of performing the above-described processing of binding the page separated from the top of another electronic document to the tail of one electronic document. That is, if the user drags the icon of electronic document “catalog” made up of three pages to an area (area indicated by the dashed line) overlapping the icon of electronic document “about course” made up of four pages and performs predetermined operation as shown at the left of the figure, the top page of the electronic document “about course” is removed, the electronic document “about course” becomes a three-page electronic document, and the removed page is bound to the tail page of the electronic document “catalog” as shown at the right of the figure.

If the user presses the key to which separating processing is assigned together with a predetermined modifier key (for example, Alt key), the tail page can also be copied and bound to the top of another electronic document.

FIG. 13 shows a processing procedure of exchanging tail page of one electronic document and the top page of another electronic document.

If the user presses a predetermined key of the keyboard in a state in which the user drags the icon of the electronic document displayed on the screen with the mouse and specifies the area to which the dragged icon is moved as the target area (the icon is contained in the target area), the operation acceptance unit 5 detects the operation and provides the information for the document operation unit 6 (steps S71 and S72).

If the user presses a key to which page exchange processing between electronic documents is assigned, the document operation unit 6 determines whether or not an electronic document exists at the position pointed to by the mouse pointer (namely, the dragged icon overlaps a different icon) (step S73). If an electronic document exists, the page ID of the tail page of the “management page ID list” of the electronic document corresponding to the dragged icon and the page ID of the top page of the “management page ID list” of the electronic document corresponding to the different icon are exchanged (step S74).

Then, the document management information updated by performing the above-described processing is stored in the memory (step S75) and the display processing unit 4 produces preview display of the icon of the post-generated/updated electronic document on the screen 2 based on the document management information in the memory (step S76) and waits until the user further presses a predetermined key.

If the user again presses the key to which exchange processing is assigned, steps S73 to S76 are repeated. If the user presses the key to which operation confirmation processing is assigned, the updated document management information stored in the memory is stored in the document retention unit 1 (step S77) and the icon preview display is released and icon is drawn based on the document management information after page operation confirmation (step S78). If the user presses the key to which cancel processing is assigned or executes drop onto a predetermined out-of-management area, the document management information stored in the memory is discarded and drawing is again performed from the beginning in the state before operation (step S78).

In the exemplary embodiment, an electronic document of a plurality of pages has been described by way of example. However, for example, the invention can also be applied to a document aggregate provided by collecting electronic documents on a binder, a tag bundle of tags added to an electronic document, etc.

In the exemplary embodiment, the “management page order” is changed in page turn, etc. However, “display page ID” for determining the page ID of a thumbnail image separately displayed may be provided as document management information and may be changed to realize page turn, etc. The top page and the tail page can also be determined based on the “display page ID.”

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document processing apparatus comprising:
a display processing unit that displays an image which represents a document having pieces of document information collectively ordered;
a target area acceptance unit that accepts specifying a target area, from a user, including first and second images which represent documents, respectively;
an operation acceptance unit that accepts a certain command from the user with the target area specified; and
an edit unit that removes, in response to the accepting of the certain command, certain document information from the document represented by the first image and that adds the removed document information to the document represented by the second image.

2. The document processing apparatus as claimed in claim 1,
wherein the target area acceptance unit accepts, as the target area, an area includes:
(i) a moving destination area to which the first image is moved in response to a user's operation of moving the first image, and
(ii) a display area of the second image, and
wherein the edit unit removes document information at the tail of the document represented by the first image and adds the removed document information to the top of the document represented by the second image.

3. The document processing apparatus as claimed in claim 1,
wherein the target area acceptance unit accepts, as the target area, an area includes:
(i) a moving destination area to which the first image is moved in response to a user's operation of moving the first image, and
(ii) a display area of the second image, and
wherein the edit unit removes document information at the top of the document represented by the second image and adds the removed document information to the tail of the document represented by the first image.

4. The document processing apparatus as claimed in claim 1,
wherein the target area acceptance unit accepts, as the target area, an area includes:
(i) a moving destination area to which the first image is moved in response to a user's operation of moving the first image, and
(ii) a display area of the second image, and
wherein the edit unit exchanges the document information at the tail of the document represented by the first image and the document information at the top of the document represented by the second image.

5. A document processing apparatus comprising:
a display processing unit that displays an image which represents a document having pieces of document information collectively ordered;
a target area acceptance unit that accepts specifying of a target area, from a user, including a first image which represents a document;
an operation acceptance unit that accepts a certain command from the user with the target area specified; and
an edit unit that creates newly, in response to the accepting of the certain command, a document represented by a second image displayed in the target area, removes certain document information from the document represented by the first image, and adds the removed document information to the document represented by the second image.

6. The document processing apparatus as claimed in claim 5,
wherein the target area acceptance unit accepts, as the target area, an area includes:
(i) a moving destination area to which the image is moved in response to a user's operation of moving the first image, and
(ii) a display area in which the second image is not displayed, and
wherein the edit unit creates newly the document represented by the second image displayed in the target area, removes document information at the tail of the document represented by the first image and adds the removed document information to the document represented by the second image.

7. The document processing apparatus as claimed in claim 5,
wherein the target area acceptance unit accepts, as the target area, an area includes:
(i) a moving destination area to which the image is moved in response to a user's operation of moving the first image, and
(ii) a display area in which the second image is not displayed, and
wherein the edit unit creates newly the document represented by the second image displayed in the target area, the edit unit removes document information at the top of the document represented by the first image and adds the removed document information to the document represented by the second image.

8. The document processing apparatus as claimed in claim 1 further comprising:
a temporary display unit that displays an image representing the contents of certain document information which is to be removed;
wherein the edit unit that removes, in response to displaying the image representing the contents of the certain document and accepting of the certain command, the certain document information from the document represented by the first image and that adds the removed document information to the document represented by the second image.

9. The document processing apparatus as claimed in claim 5 further comprising:
a temporary display unit that displays an image representing the contents of certain document information which is to be removed;
wherein the edit unit that creates newly, in response to displaying the image representing the contents of the certain document and accepting of the certain command, the document represented by the second image displayed in the target area, removes certain document information from the document represented by the first image, and adds the removed document information to the document represented by the second image.

10. The document processing apparatus as claimed in claims 1 further comprising:
a document turn unit that performs, in response to accepting of certain command for the first image, at least one of moving the document information at the top of the document to the tail of the document and moving the document information at the tail of the document to the top of the document.

11. The document processing apparatus as claimed in claims 5 further comprising:
a document turn unit that performs, in response to accepting of certain command for the first image, at least one of moving the document information at the top of the document to the tail of the document and moving the document information at the tail of the document to the top of the document.

12. A readable medium storing a program causing a computer to execute a process for document processing, the process comprising:
displaying an image which represents a document having pieces of document information collectively ordered;
accepting specifying a target area, from a user, including first and second images which represent documents, respectively;
accepting a certain command from the user with the target area specified; and
removing, in response to the accepting of the certain command, certain document information from the document represented by the first image and that adds the removed document information to the document represented by the second image.

13. A readable medium storing a program causing a computer to execute a process for document processing, the process comprising:
displaying an image which represents a document having pieces of document information collectively ordered;
accepting specifying of a target area, from a user, including a first image which represents a document;
accepting a certain command from the user with the target area specified; and
creating newly, in response to the accepting of the certain command, a document represented by a second image displayed in the target area, removes certain document information from the document represented by the first image, and adds the removed document information to the document represented by the second image.
